(19) United States
(12) Patent Application Publication
(10) Pub. No.: US 2026/0295949 A1
(43) Pub. Date: Oct. 1, 2026

(54) METHOD FOR MANUFACTURING A VANE MADE FROM COMPOSITE MATERIAL COMPRISING A SERRATION ELEMENT AND AN ANTI-EROSION COATING

(71) Applicants: SAFRAN AEROSPACE COMPOSITES, Rochester, NH (US); SAFRAN AIRCRAFT ENGINES, Paris (FR)

(72) Inventors: Matthieu Patrick Jean Roger Perlin, MOISSY-CRAMAYEL (FR); Cali Lapenta, MOISSY-CRAMAYEL (FR); Paul Myslinski, MOISSY-CRAMAYEL (FR); Alexandre Rene Roger Bedle, MOISSY-CRAMAYEL (FR)

(73) Assignees: SAFRAN AEROSPACE COMPOSITES, Rochester, NH (US); SAFRAN AIRCRAFT ENGINES, Paris (FR)

(21) Appl. No.: 19/095,484

(22) Filed: Mar. 31, 2025

(51) Int. Cl. B29C 70/44; B29C 37/00; B29C 70/68; B29L 31/08; F01D 5/28

(52) U.S. Cl. CPC B29C 70/443; B29C 37/0025; B29C 70/682; B29L 2031/082; F01D 5/282; F01D 5/288; F05D 2230/23; F05D 2230/90; F05D 2250/184; F05D 2300/603

(57) ABSTRACT

A method for manufacturing a vane made from composite material includes the steps of providing a blade portion comprising a leading edge, a trailing edge, a pressure side and a suction side and installing the portion of the blade in a tooling. The method further includes the steps of depositing at least one fibrous preform on at least one portion of the leading and/or trailing edge, the fibrous preform having a corrugated or toothed edge configured to form at least one serration element; depositing an anti-erosion coating, so as to cover the corrugated or toothed edge, and optionally at least one portion of the pressure side and/or the suction side; and densifying the fibrous preform with the portion of the blade by a resin to form the vane, and securing the fibrous preform to the anti-erosion coating with the resin.

### BACKGROUND

The disclosure relates to the field of turbomachines, in particular aircraft turbomachines, and in particular the propulsion propellers of these turbomachines which comprise vanes. More specifically, the disclosure relates to a method for manufacturing a vane made from composite material for such turbomachines, and more specifically to improving the noise reduction of these vanes during operation.

A propeller for a turbomachine, in particular an aircraft, may be ducted, as in the case of a fan for example, or may be unducted, as in the case of an “open-rotor” architecture for example.

A propeller generally comprises a plurality of vanes rotating about a longitudinal axis of the turbomachine. Each vane comprises a blade comprising a pressure side and a suction side interconnected by a leading edge and a trailing edge of the blade.

In the case of a ducted propeller, the nacelle surrounding the propeller incorporates an internal acoustic treatment to reduce noise emissions outside the turbomachine.

In the case of a non-ducted propeller, other solutions must be found to reduce propulsion noise. To remedy the problem of noise emission, a noise reduction technology already known for fans and inspired in particular by the wings of nocturnal birds of prey consists of fitting serration elements (or serrations in other words) on the trailing edges of the vanes (such as the so-called fan rotor blades) or on the leading edges of the vanes (such as the so-called stator vanes of a turbomachine stator vane). The serrations are aero-acoustic elements. They are characterized by a geometry in the form of teeth and hollows running along the trailing edge or leading edge. The serrations can lead to variations in the chord of the vane as a function of the radial height, with varying thicknesses and a very thin trailing or leading edge. The serrations can also lead to variations in the angle of the trailing or leading edge.

The principle of reducing the noise generated by the vanes is based on spatially shifting the noise sources distributed along the leading edge or trailing edge by means of serrations (or in other words corrugations or toothing), which may or may not be identical. For this principle to apply, the dimensions (height, length, thickness, etc.) of the serrations must be adapted to the incident aerodynamic field (such as the air flux passing through the vanes with more or less turbulence), which varies according to the engine speed of the turbomachine.

Today, more and more vanes are made from composite materials to reduce weight while maintaining good mechanical properties. Traditionally, vanes made from composite material are made by injecting a resin, for example by Resin Transfer Molding (RTM), into a fibrous preform.

It is known in the art to incorporate an anti-erosion coating by bonding to the blade of the vane, in particular at the serration element, in order to protect the composite structure of the vane against external damage (such as gravel, sand, etc.).

However, manufacturing the vane made from composite material comprising both the serration element and the anti-erosion coating can be time-consuming, complex and costly. The manufacturing method for such a vane requires several repetitive stages of installation, curing (or hardening) after installation, quality control and rework or repair. More particularly, the current method comprises a first step of installing the serration element and curing this serration element onto the blade of the vane, then a second step of fitting the anti-erosion coating onto this serration element and curing to secure the assembly together, and generally at least one step of retouching the vane in an autoclave before putting this vane into service, particularly in a turbomachine. This can affect the final quality of the vane produced and its long-term repairability. In fact, the greater the number of curing cycles, the more difficult it becomes to retouch or repair the composite material, since each additional cure can reduce the flexibility of the resin and fibers making up the composite material. This limits the ability to carry out effective repairs in the event of faults detected at the end of the manufacturing method, for example after quality control and/or after the vane has been put into service.

In this context, it is interesting to propose a solution that allows at least one of the above-mentioned disadvantages to be overcome, in particular by optimizing and making robust the integration of an anti-erosion coating and a serration element in a vane made from composite material for a turbomachine, while limiting the need for additional curing and maximizing the potential for reworking and repairing this vane.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure provides a simple, effective and economical solution to the aforementioned disadvantages of the prior art.

To this end, the disclosure relates to a method for manufacturing a vane made from composite material for a turbomachine, in particular for an aircraft, the vane comprising a blade comprising a leading edge, a trailing edge, a pressure side and a suction side extending between the leading edge and the trailing edge, the blade further comprising at least one serration element on the leading edge and/or the trailing edge, and at least one anti-erosion coating covering the serration element, and optionally at least part of the pressure side and/or the suction side, the method comprising the following steps of:
(a) providing a first fibrous preform intended to form a part of the blade comprising the leading edge, the trailing edge, the pressure side and the suction side,
(b) installing the first fibrous preform in a tooling,
(c) depositing, at least in part, of at least one second fibrous preform on at least one portion of at least one edge of the first fibrous preform intended to form the leading edge and/or the trailing edge in the tooling, this second fibrous preform having a corrugated or toothed edge intended to form the at least one serration element,
(d) depositing the at least one anti-erosion coating in the tooling, so as to cover the corrugated or toothed edge, and optionally at least part of a pressure side and/or suction side of the first fibrous preform, and
(e) injecting a resin into the tooling so that the resin impregnates the first and second fibrous preforms to form the vane, and securing the second fibrous preform to the anti-erosion coating with the resin.

Thus, this solution allows to achieve the above-mentioned objective. Generally speaking, the manufacturing method according to the disclosure allows to simplify and make more robust the integration of the anti-erosion coating and the serration element within the vane. To achieve this, the disclosure proposes securing both the anti-erosion coating and the second fibrous preform (intended to form the serration element) to the first fibrous preform (intended to form the blade) using the resin during step (e). This securing by co-bonding is carried out simultaneously and in a single step. In this way, the steps of the method are reduced by optimizing the curing cycle (or in other words, the polymerization and hardening of the resin) of the anti-erosion coating and the serration element to bond them to the blade of the vane in a way that is more robust and durable in operation and maintenance.

In addition, the method according to the disclosure has the following advantages:
limit the need for additional curing, in particular to bind the anti-erosion coating,
limit the reduction (or even loss) of flexibility of the resin and/or fibers making up the composite material of the vane,
maximize the retouch and repair potential of the vane, and
a significant reduction in the cost and time required to manufacture the vane.

The disclosure therefore has the advantage of being based on a design that is simple to implement, offers very high reliability and has a low cost penalty. In this way, the present disclosure helps to limit environmental impact, in particular by simplifying and perfecting the manufacture of vanes made from composite material.

The term “serration element” refers to a piece comprising teeth projecting from at least part of this piece. These teeth may be U-and/or V-shaped in axial section. These teeth can be more or less numerous, more or less large and extend along this serration element. The serrations element can also be referred to as a toothings or corrugations element.

The manufacturing method according to the disclosure may comprise one or more of the following characteristics, taken in isolation from one another or in combination with one another:
the manufacturing method further comprises a step (i) of introducing a metal reinforcement along one of the edges of the first fibrous preform which is opposite the at least one serration element, this step (i) being carried out before step (b);
the manufacturing method also comprises at least one step (ii) of compacting the second fibrous preform during or after step (c), and optionally the at least one anti-erosion coating before step (e);
before step (b) or step (c), the method comprises a step (iii₁) of depositing a surface protective layer of the first fibrous preform in the tooling, so as at least partially to cover the at least one second fibrous preform and the pressure side and/or the suction side of the first fibrous preform, and a step (iii₂) of removing the protective layer from the blade after step (e);
before step (b) or step (c), at least one first layer of adhesive is deposited on the edge of the first fibrous preform, and optionally on at least part of the pressure side and/or suction side, so that the second fibrous preform covers this first layer of adhesive in step (c);
before step (d), at least one second layer of adhesive is deposited on the corrugated or toothed edge, and optionally on the at least part of the pressure side and/or the suction side;
the step (e) is carried out by two successive curing cycles, with, respectively, a first curing parameter lower than a second curing parameter;
the first parameter is a first temperature of less than 100° C. and the second parameter is a second temperature of between 100 and 150° C., when for example the resin is epoxy;
the second fibrous preform is formed by weaving fibers or by superimposing several layers of fibers;
at least one anti-erosion coating is made of polyurethane;
step (c) is carried out before and after step (b);
the second fibrous preform is previously impregnated with the resin before step (e);
the resin is thermosetting or thermoplastic, for example epoxy-based;
the second fibrous preform is formed of woven fibers in unidirectional (1D), two dimensions (2D) or three dimensions (3D);
the second fibrous preform comprises carbon fibers, glass fibers, aramid fibers, ceramic fibers (such as silicon carbide) or a mixture of at least two of these fibers;
the corrugated or toothed edge of the second fibrous preform is intended to form corrugations or teeth of the serration element;
the anti-erosion coating has a free end with a shape similar to the corrugated or toothed edge of the second fibrous preform;
step (ii) comprises placing the anti-erosion coating and the first and second fibrous preforms under vacuum;
the first and second parameters may be temperature, pressure and/or negative pressure;
the first parameter is a first negative pressure of between −0.5 and −0.9 bar;
the second parameter is a second negative pressure of between −0.2 and −0.4 bar;
the first parameter is a first negative pressure of approximately −0.8 bar and the second parameter is a second negative pressure of approximately −0.3 bar;
step (e) is carried out in an autoclave at a constant pressure, for example between 3 and 5 bar;
the method comprises a step of surface treatment of the edge of the first fibrous preform, for example by sanding or sandblasting, carried out before step (b);
the method comprises a step (f) of final finishing and completion of the vane, such as cleaning of the vane and/or resin deburring.

The present disclosure may also relate to a vane made from composite material for a turbomachine, in particular for an aircraft, this vane being obtained by a manufacturing method according to one of the characteristics of the disclosure.

The present disclosure may also relate to an aircraft turbomachine, comprising at least one vane made from composite material according to the disclosure.

The turbomachine can be an aircraft turbojet, turboprop or turboshaft engine.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic half-view in axial section showing an aircraft turbomachine with a ducted propeller and a ducted stator vane, the propeller and the stator vane each comprising vanes;

FIG. 2 is a schematic perspective view of a turbomachine with an unducted propeller and an unducted stator vane, the propeller and the stator vane each having vanes;

FIG. 3 is a schematic profile view representing a first example of the vane of the turbomachine of FIG. 1 or FIG. 2, the vane comprising a serration element on a leading edge and an anti-erosion coating covering this serration element;

FIG. 4 is a schematic profile view representing a second example of the vane of the turbomachine of FIG. 1 or FIG. 2, the vane comprising the serration element on a trailing edge and the anti-erosion coating covering this serration element;

FIG. 5 is a schematic profile view representing a third example of the vane of the turbomachine of FIG. 1 or FIG. 2, the vane comprising a metal reinforcement on the leading edge, the serration element on the trailing edge, the anti-erosion coating covering this serration element;

FIG. 6 is a block diagram of the steps in a method for manufacturing the vane of FIG. 3, 4 or 5;

FIG. 7 is a schematic perspective view of a first fibrous preform intended to form part of a blade of the vane of FIG. 4 or 5;

FIG. 8 is a schematic profile view of a step for inserting the metal reinforcement on a first edge of the first fibrous preform obtained in FIG. 7;

FIG. 9 is a schematic profile view of the deposition of a first layer of adhesive on a second edge of the first fibrous preform obtained in FIG. 8;

FIG. 10 is a schematic view of tooling for carrying out the manufacturing method of the disclosure, comprising a mold and a first counter-mold;

FIG. 11 is a schematic perspective view of a step for depositing a second fibrous preform intended to form the serration element at the second edge of the first fibrous preform obtained in FIG. 9;

FIG. 12 is another schematic perspective view of the step of depositing the second fibrous preform on the second edge of the first fibrous preform;

FIG. 13 is a schematic perspective view of a step for depositing the anti-erosion coating on the second fibrous preform and a pressure side of the first fibrous preform obtained in FIG. 12 or 13;

FIG. 14 is another schematic perspective view of the step of depositing the anti-erosion coating on the second fibrous preform, the pressure side and the metal reinforcement of the first fibrous preform;

FIG. 15 is a schematic perspective view of the tooling comprising the assembly obtained in FIG. 13 or FIG. 14 and a second counter-mold;

FIG. 16 is a schematic view of tooling comprising a flexible membrane covering the second counter-mold of FIG. 15;

FIG. 17 shows a graph representing the parameters of the two curing cycles of a densification stage of the manufacturing method according to the disclosure;

FIG. 18 is a very schematic axial cross-sectional view of a first example of the anti-erosion coating covering the second fibrous preform and the pressure side of the first fibrous preform during the resin injection step;

FIG. 19 is a very schematic axial cross-sectional view of a second example of the anti-erosion coating covering the second fibrous preform and the suction side of the first fibrous preform during the resin injection stage;

FIG. 20 is a very schematic axial cross-sectional view of a third example of the anti-erosion coating covering the second fibrous preform and the pressure side and suction side of the first fibrous preform during the resin injection stage.

The elements with the same functions in the different implementations have the same references in the figures.

### DETAILED DESCRIPTION

By convention, in the following description, the terms “longitudinal” and “axial” refer to the orientation of structural elements extending in the direction of a longitudinal axis (such as a turbomachine or a vane for example of this turbomachine). The terms “radial” or “vertical” refer to an orientation of structural elements extending along a direction perpendicular to the longitudinal axis. The terms “inner” and “outer”, and “internal” and “external” are used in reference to a positioning with respect to the longitudinal axis. Thus, a structural element extending along the longitudinal axis comprises an inner face facing the longitudinal axis and an outer surface opposite its inner surface.

The disclosure can be applied in a non-limiting way to a turbomachine 10, in particular an aircraft. The turbomachine 10 can be an aircraft turbojet, turboprop or turboshaft engine.

The turbomachine 10 can extend around a longitudinal axis X.

The turbomachine 10 can conventionally comprise a gas generator that drives at least one propeller 1. The gas generator comprises at least one compressor, a combustion chamber and at least one turbine. The rotor or one of the rotors of the gas generator is connected to the rotor of the propeller to drive it in rotation.

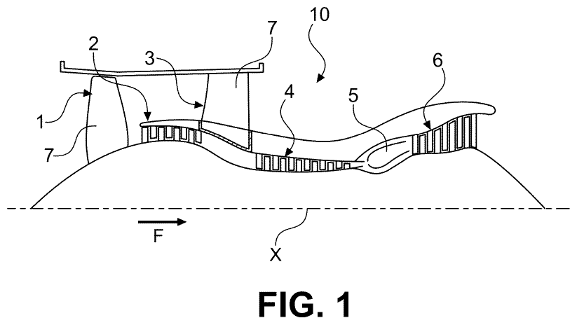

A propeller 1 can be ducted (FIG. 1). This is the case of a fan in a turbomachine of the turbojet or turbofan type, for example.

By way of example and without limitation, FIG. 1 illustrates such a turbomachine 10 comprising, from upstream to downstream in the direction of gas flow F along the axis X, the ducted propeller 1 (also known as the fan), at least one compressor (such as a low-pressure compressor 2 and/or a high-pressure compressor 4), a combustion chamber 5, at least one turbine 6 (such as a high-pressure turbine and/or a low-pressure turbine) and a nozzle (not referenced in FIG. 1).

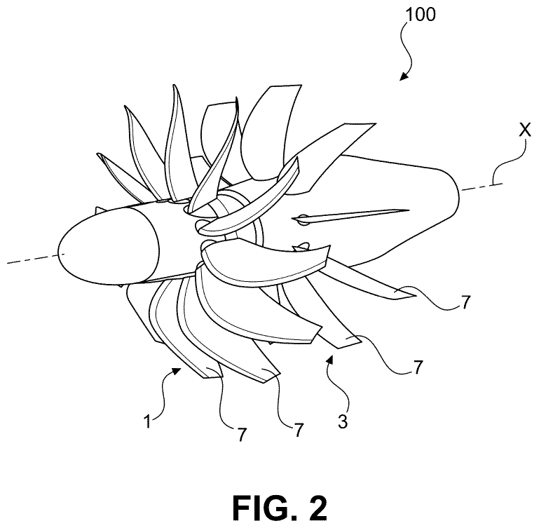

A propeller 1 can be unducted (FIG. 2). This is the case with a turboprop engine, for example.

By way of example and without limitation, FIG. 2 illustrates such a turbomachine 10 comprising the unducted propeller 1.

The turbomachine 10 may therefore comprise the propeller 1, whether ducted or unducted, upstream and a stator vane 3 downstream.

The propeller 1 may comprise vanes 7 (known as rotor blades) extending around the axis X. The vanes 7 of the propeller 1 allow an air flux to be drawn in. This air flux, in the case of the turbomachine 10 shown in FIG. 1, can be divided into a primary flux and a secondary flux. The primary flux passes through a primary duct in the turbomachine 10, while the secondary flux is directed towards a secondary duct surrounding the primary duct.

The stator vane 3 comprises vanes 7 (known as stator blades) extending around the axis X. The vanes 7 of the stator vane 3 are used to straighten the flux at the outlet of an upstream rotor in order to provide maximum thrust at the outlet of the turbomachine 10.

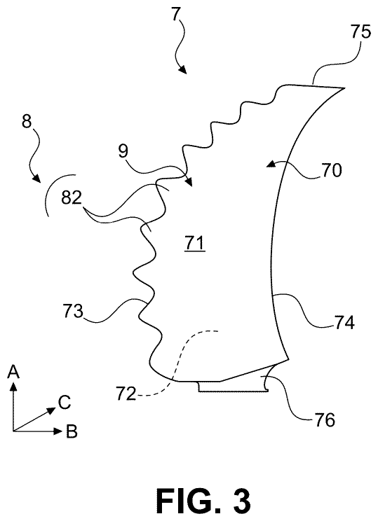

In the following description, the disclosure will be described in the context of its non-limiting application to the vane 7, in particular in reference to FIGS. 3 to 5. This vane 7 may be movable on the propeller 1 or fixed on the stator vane 3.

The vane 7 can extend as follows:
an axis of elongation A (substantially vertical in FIGS. 3 to 5) which is substantially perpendicular or inclined to the axis X of the turbomachine 10,
a longitudinal axis B (substantially horizontal in FIGS. 3 to 5) which is substantially perpendicular to axis B, and
a transverse axis C which is substantially perpendicular to axes A and B.

The vane 7 comprises a blade 70 which can be connected to a root 76 of the vane. The blade 70 comprises a leading edge 73, a trailing edge 74, a pressure side 71 and a suction side 72 extending between the leading edge 73 and the trailing edge 74.

The blade 70 can have an aerodynamic profile to form the aerodynamic part of the vane 7. To achieve this, the blade 70 can have a curved profile of variable thickness between the leading edge 73 and its trailing edge 74 of the vane 7.

In the examples shown in FIGS. 3 to 5, the blade 70 can extend along the axis A between a first end and a second end opposite the first end.

The root 76 can be connected to the second end of the blade 70. It is intended to be fixed to a disc (not shown) which can rotate about the axis X, for example. The second end is free and configured to form a top 75 (or head) of a vane 7.

The vane 7 is made from composite material. At least part of the blade 70 of the vane 7 may comprise (or be formed from) a first fibrous preform 700 which may be embedded in a resin.

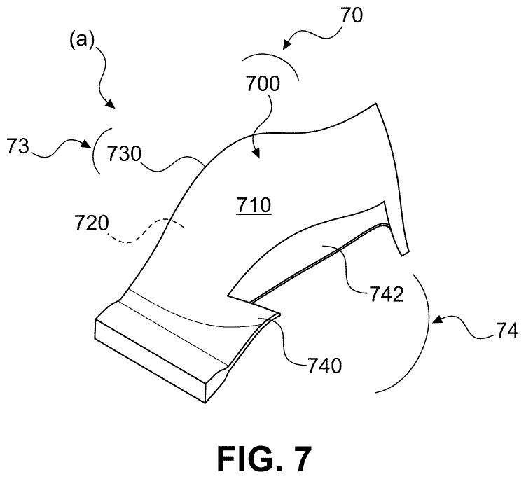

FIG. 7 provides a non-limiting illustration of the first fibrous preform 700. This first fibrous preform 700 may comprise a first edge 730 intended to form the leading edge 73 of the blade 70, a second edge 740 intended to form the trailing edge 74 of this blade. The first fibrous preform 700 may comprise a pressure side 710 intended to form the pressure side 71 of the blade 70 and a suction side 720 intended to form the suction side 72.

The first fibrous preform 700 can be obtained by any prior art technique from a fibrous reinforcement (obtained for example by 1D, 2D or 3D weaving, or by multi-layer draping, etc.) shaped and/or compacted, before carrying out in particular the resin injection step described below.

The blade 70 also comprises at least one serration element 8 on at least part of the leading edge 73 and/or at least part of the trailing edge 74. As mentioned below, the serration element reduces the aerodynamic noise generated by the vane during operation.

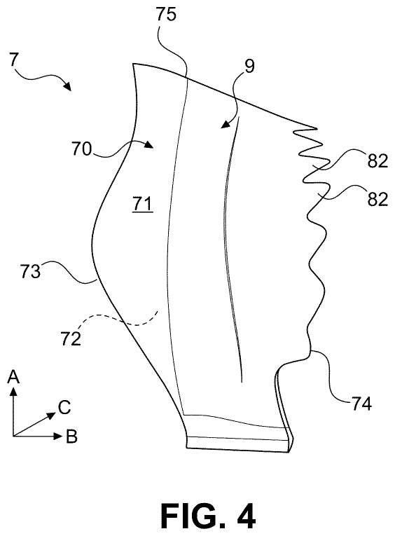

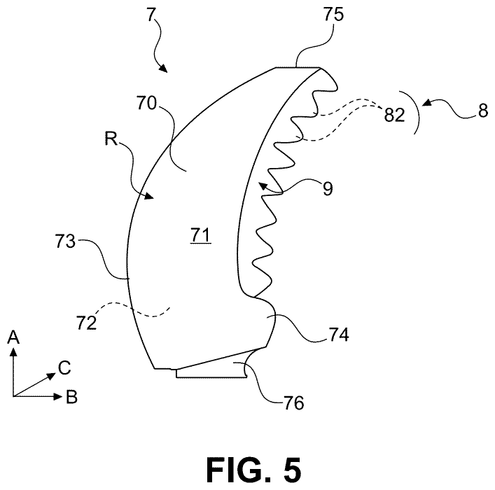

The blade 70 can thus comprise a serration element 8 located either at the leading edge 73 (FIG. 3) or at the trailing edge 74 (FIGS. 4 and 5), or two different serration elements 8 located, respectively, on the leading edge 73 and the trailing edge 74 (not shown in the figures). By way of example, the serration element 8 can be located on the leading edge 73 when the vane 7 corresponds to that of the propeller 1 of the unducted turbomachine. The serration element 8 can be on the trailing edge 74 when the vane 7 corresponds to that of the stator vane 3 of the ducted turbomachine.

The serration element 8 may comprise corrugations or teeth 82 (or, in other words, projecting portions). For example, the serration element 8 may comprise between five and twenty teeth 82. These corrugations or teeth 82 may be aligned with one another, particularly along the leading edge 73 or the trailing edge 74. The corrugations or teeth 82 may extend over part or all of the leading edge 73 and/or the trailing edge 74. The corrugations or teeth 82 can be defined to reduce noise in the average emission spectrum without making other frequencies too much worse at other engine speeds.

The corrugations or teeth 82 may be identical or different in shape.

The corrugations or teeth 82 may each have a generally polygonal shape (such as triangular, rectangular, etc.).

The corrugations can have a profile that obeys a periodic law, for example a sinusoidal type. For example, the corrugations may be in the form of a periodic signal with one or more harmonics.

The corrugations or teeth 82 may be distributed more or less evenly along the leading edge 73 and/or the trailing edge 74.

The serration element 8 can cause variations in the chord of the vane as a function of the radial height (relative to axis A), with variable thicknesses and a very thin leading edge 73 or trailing edge 74.

The serration element 8 can be attached to the blade 70 with a first layer of adhesive 702. This first layer of adhesive 702 may be located between, on the one hand, the leading edge 73 and/or trailing edge 74 and possibly on at least part of the pressure side 71 and/or suction side 72, and, on the other hand, the serration element 8.

The first layer of adhesive 702 may be made of resin, for example epoxy-based.

The serration element 8 may comprise (or be formed from) at least one second fibrous preform 800 which may be embedded (or otherwise polymerized and cured) in a resin (or otherwise a polymeric matrix after polymerization of the resin).

The second fibrous preform 800 can be formed from fibers woven, for example, unidirectionally (1D), in two dimensions (2D) or in three dimensions (3D). Alternatively, the second fibrous preform 800 can be multi-layered, for example by superimposing several layers of fiber.

The second fibrous preform 800 may comprise carbon fibers, glass fibers, aramid fibers, ceramic fibers (such as silicon carbide) or a mixture of at least two of these fibers.

The second fibrous preform 800 may comprise a corrugated or toothed edge 802 intended to form the serration element 8 (in particular the corrugations or teeth 82).

The fibrous preform 800 can be pre-impregnated with the resin. The term “fibrous preform” refers to an intermediate part used to manufacture the final vane 7. In particular, the first fibrous preform 700 may be intended to form at least part of the blade 70 comprising, for example, the pressure side 71, the suction side 72, the leading edge 73 and the trailing edge 74, and optionally the root 76. The second fibrous preform 800 can be used to form the serration element 8.

The composite material can be, for example, an organic matrix composite (OMC).

The organic matrix composites (OMCs) are used to replace metal parts in certain parts of the turbomachine (such as the vanes). In addition, their use helps to optimize aircraft performance, in particular by improving the turbomachine efficiency and reducing the overall weight of the turbomachine, significantly reducing the emissions that are harmful to the environment (CO, CO2, NOx, etc.).

The resin can be thermosetting or thermoplastic, for example epoxy-based.

The blade 70 also comprises at least one anti-erosion coating 9 covering the serration element 8, and possibly at least part of the pressure side 71 and/or at least part of the suction side 72. As mentioned above, the anti-erosion coating 9 protects the composite structure of the vane against external aggression (such as gravel, sand, etc.).

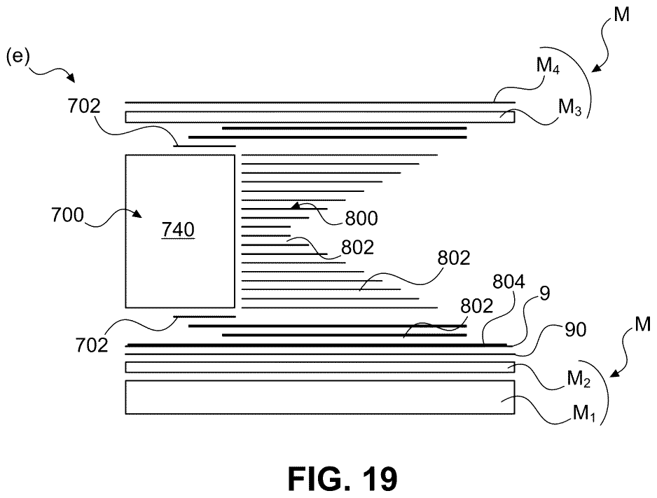

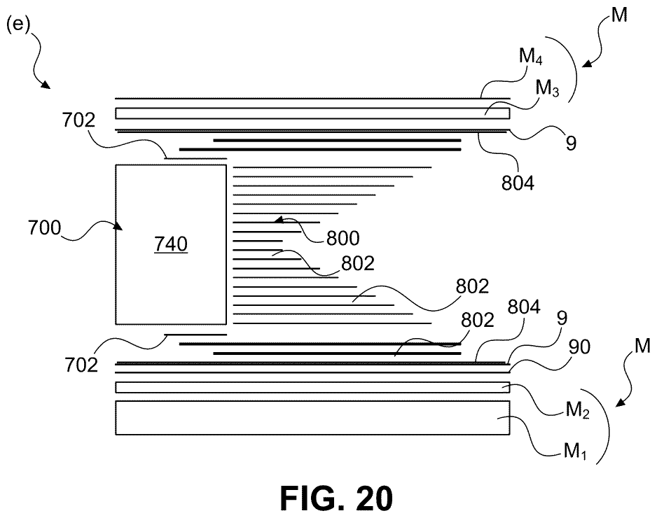

The blade 70 can thus comprise an anti-erosion coating 9 covering the serration element 8 and also located either on the pressure side 71 (FIGS. 3 to 5, 13, 14 and 18) or on the suction side (FIG. 19); or two different anti-erosion coatings 9 covering the serration element 8 and located on the pressure side 71 and the suction side respectively (FIG. 20).

The anti-erosion coating 9 may have a free end similar in shape to the corrugated or toothed edge 802 of the second fibrous preform 800.

The anti-erosion coating 9 can be made of polyurethane.

The anti-erosion coating 9 can be less than 300 μm thick. Preferably, the thickness of the anti-erosion coating 9 can be around 250 μm.

The anti-erosion coating 9 can be attached to the blade 70 with a second layer of adhesive 804. This second layer of adhesive 804 may be located between the anti-erosion coating 9 and the serration element 8, and possibly at least part of the pressure side 71 and/or at least part of the suction side 72.

The second layer of adhesive 804 may be similar to the first layer of adhesive 702. Preferably, the second layer of adhesive 804 can be made of resin, for example epoxy-based.

In addition, the vane 7 can optionally include a metal reinforcement R (FIG. 5). This metal reinforcement R can cover at least part of the leading edge 73 or the trailing edge 74. The metal reinforcement R can preferably extend along one of the leading edge 73 and trailing edge 74 opposite the serration element 8.

Advantageously, the metal reinforcement R can extend over the entire height (with respect to the axis A) and over a longitudinal portion (with respect to the axis B) of the pressure side 71 and the suction side 72 from the leading edge 73.

Preferably, the metal reinforcement R can be U-shaped or V-shaped in cross-section relative to the axis A, so as to at least partially cover the leading edge 73 or the trailing edge 74.

The metal reinforcement protects the vane (in particular the blade of the vane) against outer impacts (gravel from a runway, hailstones, birds, etc.) and against erosion of the vane.

The metal reinforcement R can be fixed by gluing or by spraying a film, for example a metal film.

The metal material of the metal reinforcement R is, for example, titanium or an alloy such as steel (e.g. stainless steel) or a nickel-cobalt alloy (NiCo).

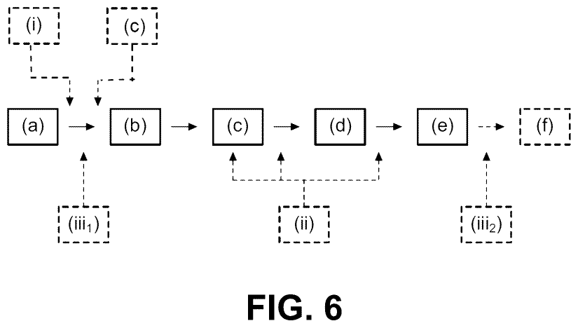

With reference to FIGS. 6 to 20, this application will now describe a method for manufacturing the vane 7 as described above.

In accordance with the disclosure, the method for manufacturing the vane 7 made from composite material comprises the following steps:
(a) providing the first fibrous preform 700 intended to form part of the blade 70 comprising the leading edge 73, the trailing edge 74, the pressure side 71 and the suction side 72,
(b) installing the first fibrous preform 700 in a tooling M,
(c) depositing at least part of the second fibrous preform 800 on at least one portion of at least one edge 730, 740 intended to form the leading edge 73 and/or the trailing edge 74 in the tooling M, this second fibrous preform 800 having the corrugated or toothed edge 802,
(d) depositing the at least one anti-erosion coating 9 in the tooling M, so as to cover the corrugated or toothed edge 802, and optionally the at least part of the pressure side 710 and/or suction side 720 of the first fibrous preform 700, and
(e) injecting a resin into the tooling M so that the resin impregnates the first 700 and second 800 fibrous preforms to form the vane 7, and securing the second 800 fibrous preform to the anti-erosion coating 9 with the resin.

FIG. 6 summarizes the steps in the manufacturing method of the disclosure, in which the optional steps in the method are shown in dotted lines.

For carrying out the method according to the disclosure, the tooling M may comprise a mold M₁, a first counter-mold M₂, a second counter-mold M₃, and optionally a flexible membrane M₄.

The mold M₁ can be rigid. The mold M₁ may comprise a cavity designed to receive the first 700 and second 800 fibrous preforms, the anti-erosion coating 9 and possibly the metal reinforcement R.

The first counter-mold M₂ can be placed on the mold M₁ and configured to receive the pressure side or suction side of the assembly (i.e. the pressure side 710 or the suction side 720 of the first fibrous preform 700) to carry out step (e). This assembly is composed of the first fibrous preform 700 obtained in step (a), the second fibrous preform 800 deposited in step (c), the anti-erosion coating 9 deposited in step (d), and optionally the metal reinforcement R introduced in step (i).

The first counter-mold M₂ can be made of silicone.

The second counter-mold M₃ can be located opposite the mold M₁ and the first counter-mold M₂. This second counter-mold M₃ can be configured to receive the other side (suction side 720 or pressure side 710 of the first fibrous preform 700) of the assembly for carrying out step (e).

The second counter-mold M₃ can be made of silicone. This second counter-mold M₃ may have a hardness Shore A (or durometer) than the first counter-mold M₂. In other words, the second counter-mold M₃ can be more flexible than the first counter-mold M₂.

The flexible membrane M₄ can be unperforated. This flexible membrane M₄ can be used as a vacuum bag. The flexible membrane can also be used to lock the tooling containing the assembly so that step (e) can be carried out.

As mentioned above, in step (a), the first fibrous preform 700 can be made by weaving fibers in two dimensions or in three dimensions.

FIG. 7 illustrates, in a non-limiting manner, the first fibrous preform 700 of step (a) in which the second edge 740 of the first fibrous preform 700 is dimensioned to receive the second fibrous preform 800. More particularly, this second edge 740 may have at least one thinned zone 742 in thickness configured to receive the second fibrous preform 800 in step (c). This tapered area 742 may, for example, form a groove.

The method may further comprise a step (i) of introducing the metal reinforcement R along one of the edges 730 and 740 opposite the at least one serration element 8. This step (i) can be carried out before step (b).

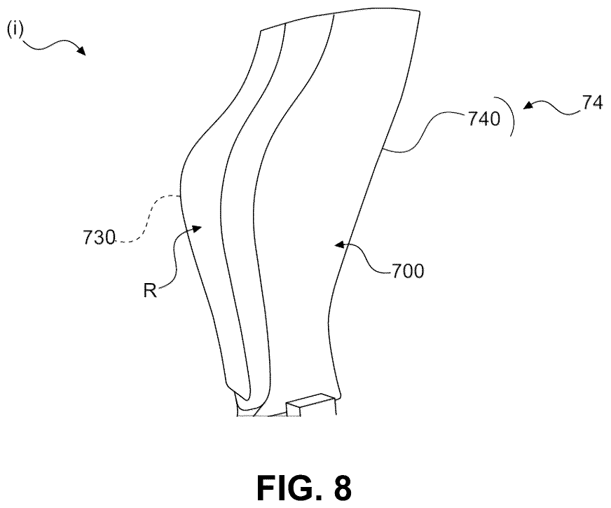

FIG. 8 is a non-limiting illustration of the metal reinforcement R along the second edge 740 of step (i).

The method may include a step of surface treatment of the first fibrous preform 700 obtained in step (a). This surface treatment step may be carried out before step (b) or before step (i).

The surface treatment may be carried out on the first edge 730 and/or the second edge 740 intended to receive the second fibrous preform 800 and/or the metal reinforcement R.

The surface treatment can be carried out by sanding or sandblasting.

At least one first layer of adhesive 702 can be deposited on the edge 730, 740 of the first fibrous preform 700, and optionally on at least part of the pressure side 710 and/or the suction side 720 of the first fibrous preform 700. This first layer of adhesive 702 can be covered by the second fibrous preform 800 in step (c).

The first layer of adhesive 702 can be deposited before step (b) or step (c).

The first layer of adhesive 702 can be deposited before step (i) or after step (i), particularly when the metal reinforcement R is introduced before step (b).

As described above, the first layer of adhesive 702 may be epoxy-based.

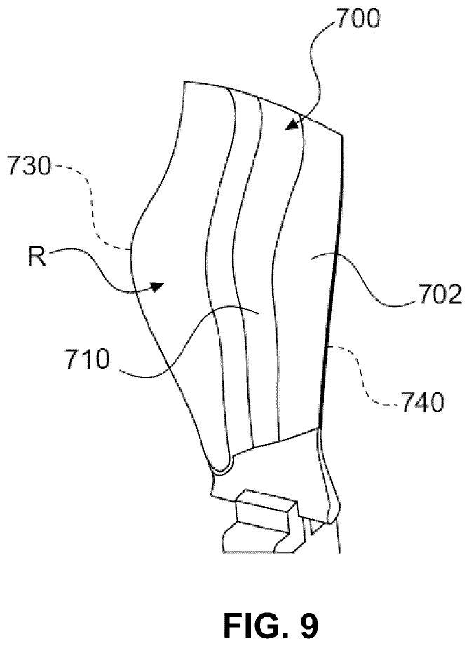

FIG. 9 is a non-limiting illustration of the first layer of adhesive 702 on the second edge 740 of the first fibrous preform 700, in particular before step (b). This first fibrous preform 700 thus comprises the metal reinforcement R introduced prior to the deposition of the first layer of adhesive 702.

In step (b), the first fibrous preform 700 can be placed in the cavity of the mold M₁ and the first counter-mold M₂. This cavity may have a shape complementary to the first fibrous preform 700 (as shown non-limitatively in FIG. 7) and the second fibrous preform 800.

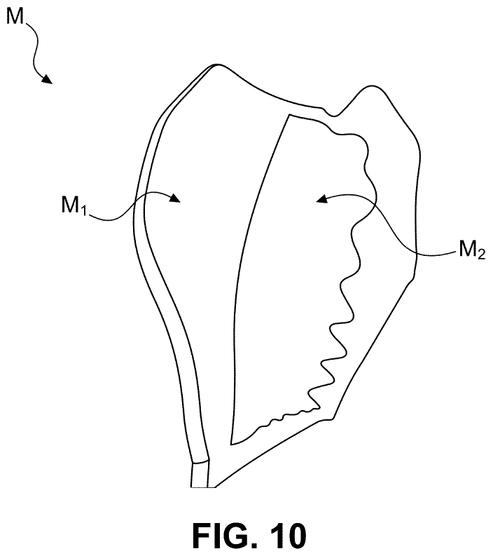

FIG. 10 illustrates, in a non-limiting way, part of the tooling M consisting of the mold M₁ and the first counter-mold M₂ which are intended to receive the first fibrous preform 700 in step (b), then the other component elements of the vane 7 to be manufactured (such as the second fibrous preform 800, the anti-erosion coating 9, the metal reinforcement R, a protective layer 90 described below, the first layer of adhesive 702, etc.).

The method may comprise a step (iii₁) of depositing the protective layer 90 on the surface of the first fibrous preform 700 in the tooling M, so as to at least partially cover the second fibrous preform 800 and the pressure side 710 and/or the suction side 720 of the first fibrous preform 700. This step (iii₁) can be carried out before step (b).

In particular, the protective layer 90 prevents dust, debris and other contaminants from accumulating on the first fibrous preform 700 during the manufacturing method.

The protective layer 90 may comprise a film known as a peel ply. In particular, this peel ply gives the vane 7 a rough surface.

The method may include a step (iii₂) of removing the protective layer 90. This step (iii₂) can be carried out after step (e).

Advantageously, step (c) can be carried out before or after step (b). Indeed, at least one first part of the second fibrous preform 800 can be deposited in the tooling M, then at least one second part of the second fibrous preform 800 can be deposited on the edge 730, 740 of the first fibrous preform 700 in the tooling M. The first part of the second fibrous preform 800 may be intended to form a pressure side of the serration element, and the second part of the second fibrous preform 800 may be intended to form a suction side of the serration element; or vice versa.

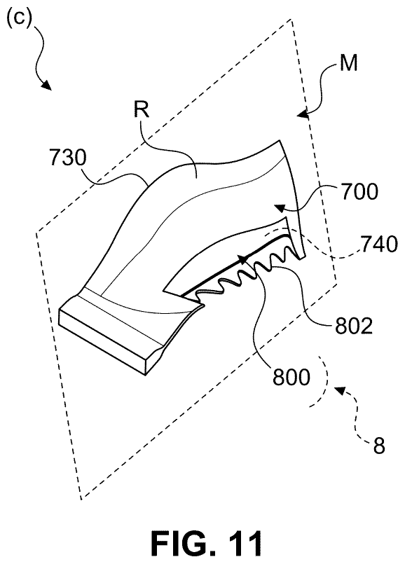

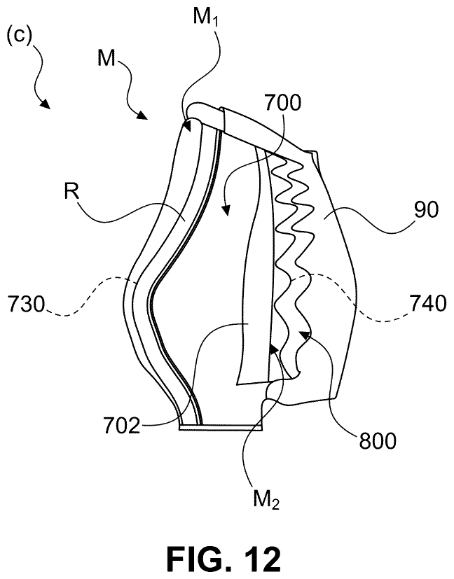

Several possible configurations for carrying out step (c) are shown in FIGS. 11 and 12. With reference to FIG. 11, the second fibrous preform 800 may be positioned on the tapered area 742 at the second edge 740 of the first fibrous preform 700 in step (c).

FIG. 12 shows the first 700 and second fibrous preforms in tooling M in greater detail.

As described above, the second fibrous preform 800 can be formed by weaving fibers or by superimposing several layers of fibers.

The second fibrous preform 800 may extend over at least 70% of the length (with respect to axis A) of the edge portion 730, 740 of the first fibrous preform 700.

The second fibrous preform 800 can be pre-impregnated with the resin before step (e). Alternatively, the second fibrous preform 800 can be said to be dry (i.e. without prior resin impregnation), and the resin is injected in step (e) in this case to bond the second fibrous preform 800 to the anti-erosion coating 9.

At least one second layer of adhesive 804 can be applied to the corrugated or toothed edge 802, and possibly to at least part of the pressure side 710 and/or the suction side 720. This second layer of adhesive 804 can be covered by the anti-erosion coating 9 in step (d).

The second layer of adhesive 804 can be deposited before step (d).

As described above, the second layer of adhesive 804 can be epoxy-based.

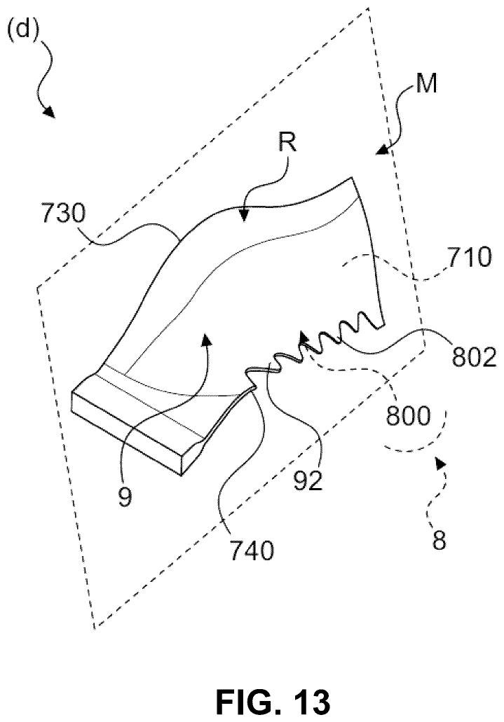

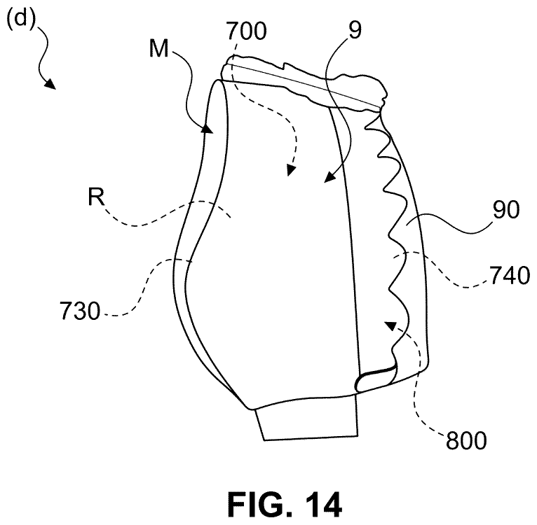

Several possible configurations for carrying out step (d) are shown in FIGS. 13 and 14.

FIG. 13 is a non-limiting illustration of the anti-erosion coating 9 deposited on the second fibrous preform 800 at the second edge 740 and the pressure side 710 of the first fibrous preform 700 in step (d).

FIG. 14 shows another configuration of step (d) in which the anti-erosion coating 9 is deposited on the second fibrous preform 800, the pressure side 710 and also the first edge 730 covered by the metal reinforcement R.

As described above, the anti-erosion coating 9 can be made of polyurethane.

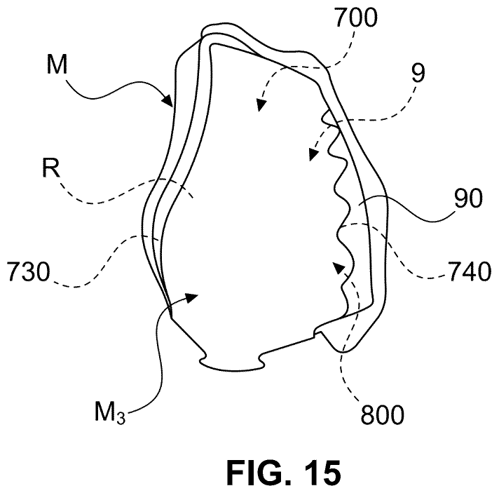

FIG. 15 is a non-limiting illustration of the second counter-mold M₃ covering the assembly for carrying out step (e).

The method may also include at least one step (ii) of compacting the second fibrous preform 800, and possibly the anti-erosion coating 9.

Step (ii) of compacting the second fibrous preform 800 may be carried out at least once or several times during or after step (c).

The second fibrous preform 800 and the anti-erosion coating 9 can be compacted before step (e).

Step (ii) may be carried out by applying a vacuum, so as to apply a predetermined pressure to achieve the desired compaction of the second fibrous preform 800, and optionally the anti-erosion coating 9, with the first fibrous preform 700.

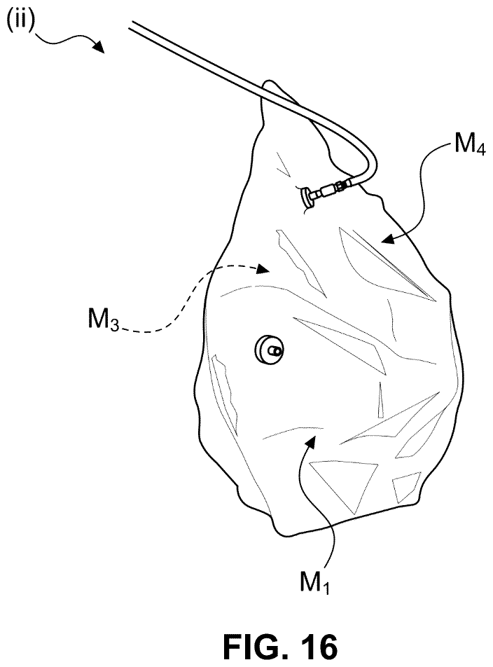

FIG. 16 illustrates, in a non-limiting way, the compaction of the first fibrous preform 700 comprising the second fibrous preform 800, the anti-erosion coating 9 and possibly the metal reinforcement R by the flexible membrane M₄.

Step (e) allows the resin to cure, hardening and securing the second fibrous preform 800 to the anti-erosion coating 9.

This step (e) may comprise at least one curing cycle, for example at a temperature of between 100 and 180° C., preferably around 150° C. More particularly, step (e) can be carried out by two successive curing cycles, each with a first curing parameter lower than a second curing parameter. The first curing cycle allows the exothermicity of the resin in the second fibrous preform 800 to be controlled in step (e), and the second curing cycle allows the serration element 8, the anti-erosion coating 9 and optionally the metal reinforcement R to be simultaneously bonded to the blade 70.

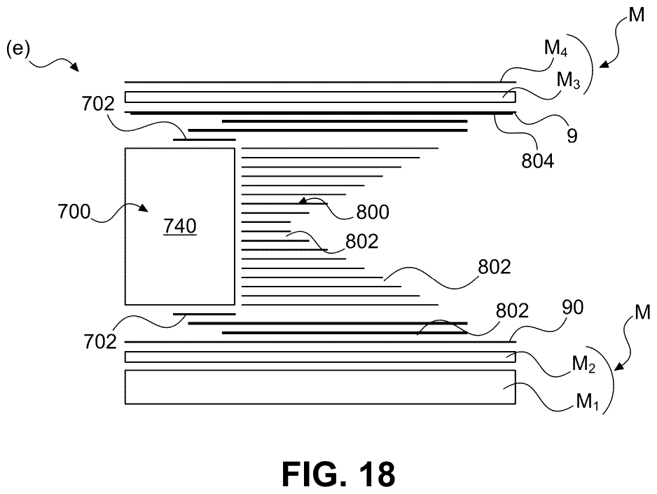

The first and second curing parameters can be a temperature, a pressure (or a negative pressure in the case of FIG. 18) and/or a time.

The first parameter may be a first temperature below 100° C., for example when the resin is epoxy. Preferably, the first temperature can be around 90° C. The second parameter may be a second temperature of between 100 and 150° C. when, for example, the resin is epoxy. Preferably, the second temperature can be around 150° C.

The first parameter can be a first negative pressure of between −0.5 and −0.9 bar, preferably around −0.8 bar. The second parameter can be a second negative pressure of between −0.2 and −0.4 bar, preferably around −0.3 bar.

Step (e) can be carried out in an autoclave at a constant pressure, for example between 3 and 5 bar. Preferably, the constant autoclave pressure can be around 4.5 bar.

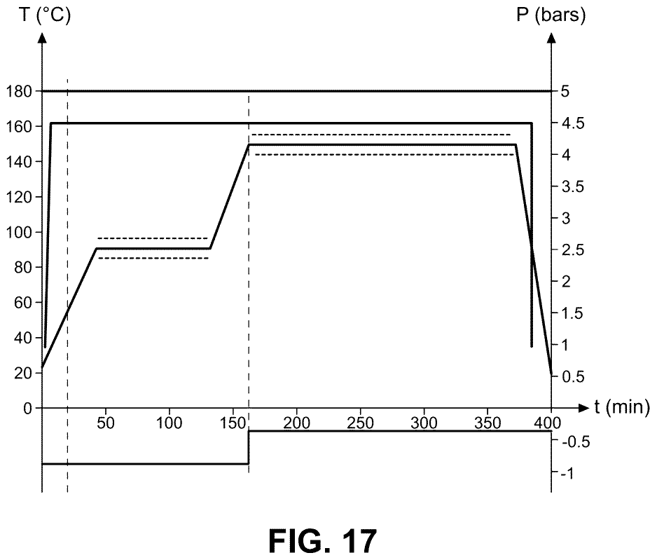

FIG. 17 illustrates, in a non-limiting way, the parameters of the two curing cycles when the resin of the blade 70 and the resin used to join the serration element 8 and the anti-erosion coating 9 are epoxy-based:
the first curing cycle can be carried out at a first temperature of approximately 90° C., a first negative pressure (or vacuum) of approximately −0.8 bar and a first duration of approximately 60 minutes, and
the second cycle can be carried out with the second temperature of approximately 150° C., the second negative pressure (or vacuum) −0.3 bars and a second duration of approximately 210 min.

FIGS. 18 to 20 illustrate in a non-limiting manner the anti-erosion coating 9 covering the corrugated or toothed edge 802 at the second edge 740 and the pressure side 710 and/or the suction side 720 of the first fibrous preform 700 to carry out step (e).

FIG. 18 shows the anti-erosion coating 9 covering the corrugated or toothed edge 802 and the pressure side 710 of the first fibrous preform 700.

FIG. 19 shows the anti-erosion coating 9 covering the corrugated or toothed edge 802 and the suction side 720 of the first fibrous preform 700.

FIG. 20 shows the anti-erosion coating 9 covering the corrugated or toothed edge 802, the pressure side 710 and the suction side 720 of the first fibrous preform 700.

The method may include a step (f) of final finishing and completion of the vane 7. For example, step (f) may involve cleaning the vane 7 and/or deburring to remove excess resin from the vane 7.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for manufacturing a vane made from composite material for a turbomachine, the vane having a blade that includes a leading edge, a trailing edge, a pressure side, a suction side extending between the leading edge and the trailing edge, at least one serration element on the leading edge and/or the trailing edge, and at least one anti-erosion coating covering the serration element, the method comprising the steps of:
(a) providing a first fibrous preform configured to form a part of the blade comprising the leading edge, the trailing edge, the pressure side and the suction side,
(b) installing the first fibrous preform in a tooling,
(c) depositing, at least in part, at least one second fibrous preform on at least one portion of at least one edge of the first fibrous preform configured to form the leading edge and/or the trailing edge in the tooling, this second fibrous preform having a corrugated or toothed edge configured to form the at least one serration element,
(d) depositing the at least one anti-erosion coating in the tooling, so as to cover the corrugated or toothed edge, and optionally the at least part of a pressure side and/or a suction side of the first fibrous preform, and
(e) injecting a resin into the tooling so that the resin impregnates the first and second fibrous preforms to form the vane, and securing the second fibrous preform to the anti-erosion coating with the resin.

2. The method according to claim 1, further comprising a step (i) of introducing a metal reinforcement (R) along one of the edges of the first fibrous preform, which is opposite the at least one serration element, wherein step (i) is carried out before step (b).

3. The method according to claim 2, further comprising at least one step (ii) of compacting the second fibrous preform during or after step (c).

4. The method according to claim 3, further comprising, before step (b) or step (c), a step (iii₁) of depositing a surface protective layer of the first fibrous preform in the tooling, so as at least partially to cover the at least one second fibrous preform and the pressure side and/or the suction side of the first fibrous preform, and a step (iii₂) of removing the protective layer from the blade after step (e).

5. The method according to claim 1, wherein before step (b) or step (c), at least one first layer of adhesive is deposited on the edge of the first fibrous preform so that the second fibrous preform covers this first layer of adhesive in step (c).

6. The method according to claim 5, wherein before step (d), at least one second layer of adhesive is deposited on the corrugated or toothed edge.

7. The method according to claim 1, wherein step (e) is carried out by two successive curing cycles, with, respectively, a first curing parameter lower than a second curing parameter.

8. The method according to claim 7, wherein the first parameter is a first temperature of less than 100° C. and the second parameter is a second temperature of between 100 and 150° C.

9. The method according to claim 8, wherein the resin is epoxy.

10. The method according to claim 1, wherein the second fibrous preform is formed by weaving fibers or by superimposing several layers of fibers.

11. The method according to claim 1, wherein the at least one anti-erosion coating is made of polyurethane.

12. The method according to claim 1, wherein the at least one anti-erosion coating covers at least part of the pressure side and/or the suction side, and the at least one anti-erosion coating deposited in the tooling in step (d) covers the at least part of a pressure side and/or a suction side of the first fibrous preform.

13. The method according to claim 12, further comprising at least one step (ii) of compacting the second fibrous preform during or after step (c), and the at least one anti-erosion coating before step (e).

14. The method according to claim 12, wherein before step (b) or step (c), at least one first layer of adhesive is deposited on the edge of the first fibrous preform, and on at least part of the pressure side and/or suction side, so that the second fibrous preform covers this first layer of adhesive in step (c).

15. The method according to claim 12, wherein before step (d), at least one second layer of adhesive is deposited on the corrugated or toothed edge, and on the at least part of the pressure side and/or the suction side.
